(19) United States
(12) Patent Application Publication
(10) Pub. No.: US 2026/0185399 A1
(43) Pub. Date: Jul. 2, 2026

(54) HIDDEN DOOR MECHANISM

(71) Applicant: Roaring Hospitality LLC, Cumming, GA (US)

(72) Inventors: Stephen Boortz de Haan, Cumming, GA (US); Nicholas Alexander Lamb, JR., Alpharetta, GA (US)

(21) Appl. No.: 19/427,907

(22) Filed: Dec. 19, 2025

Related U.S. Application Data
(60) Provisional application No. 63/738,911, filed on Dec. 26, 2024.

(51) Int. Cl. E06B 3/70; E05D 7/00; E05F 1/10; E05F 15/611; E06B 5/00

(52) U.S. Cl. CPC E06B 3/7001; E05D 7/009; E05F 1/10; E05F 15/611; E06B 5/00; E05Y 2400/85; E05Y 2900/132

(57) ABSTRACT

A system includes a phone booth. The phone booth includes a booth door and two booth walls. The two booth walls are connected to an exterior side of a wall of a building and are perpendicular with the booth door. The phone booth is embedded into a ground surface. Further, the system includes a hidden door parallel to the booth door and, when opened, provides access to an interior portion of the building. Additionally, the system includes a telephone backplate to disguise the hidden door. Moreover, the system includes a telephone connected to the telephone backplate. The telephone facilitates communication via a communication connector between the phone booth and an interior side of the wall in the building.

### CROSS-REFERENCE TO RELATED APPLICATIONS

This application claims the benefit of U.S. Provisional Application No. 63/738,911 filed on Dec. 26, 2024, and titled “HIDDEN DOOR MECHANISM.” U.S. Provisional Application No. 63/738,911 is hereby incorporated herein by reference.

### BACKGROUND

Concealed doors are used for a variety of practical and aesthetic reasons. One way to hide a door is to make it a part of an unrelated fixture that a person would assume is completely unrelated to a door. The door would need to seamlessly fit into the fixture that hides the door.

### DETAILED DESCRIPTION

Certain embodiments disclosed herein will be described with reference to the accompanying drawings. However, the accompanying drawings illustrate only certain aspects or implementations of one or more embodiments disclosed herein by way of example and are not meant to limit the scope of the claims.

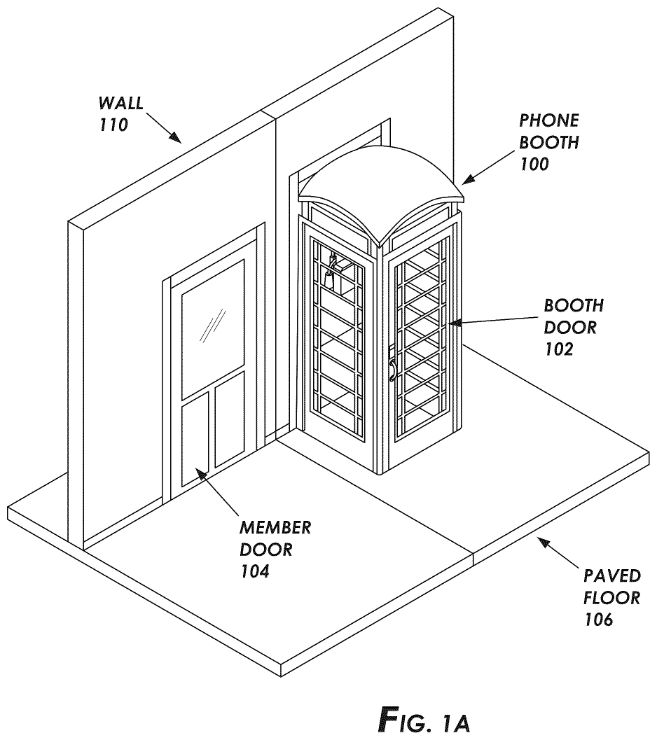

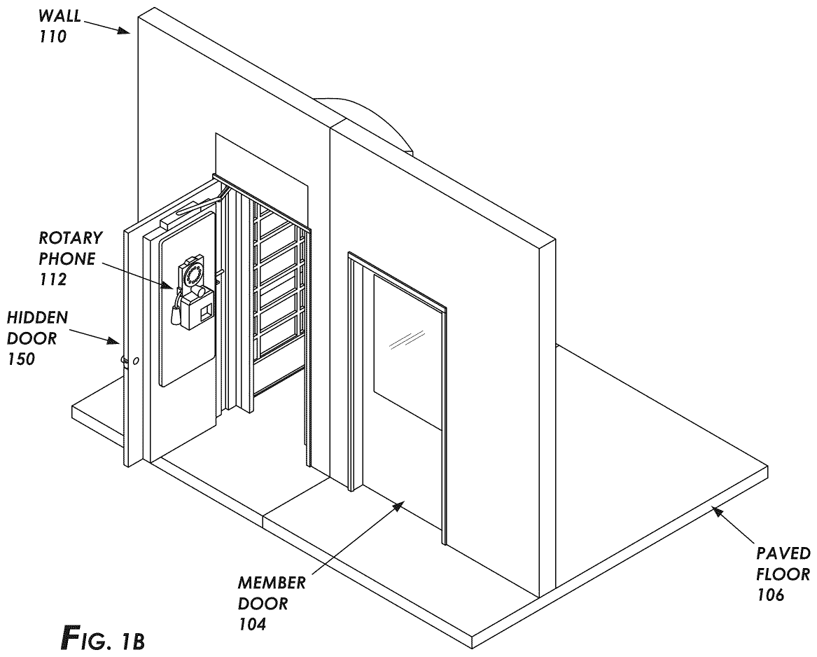

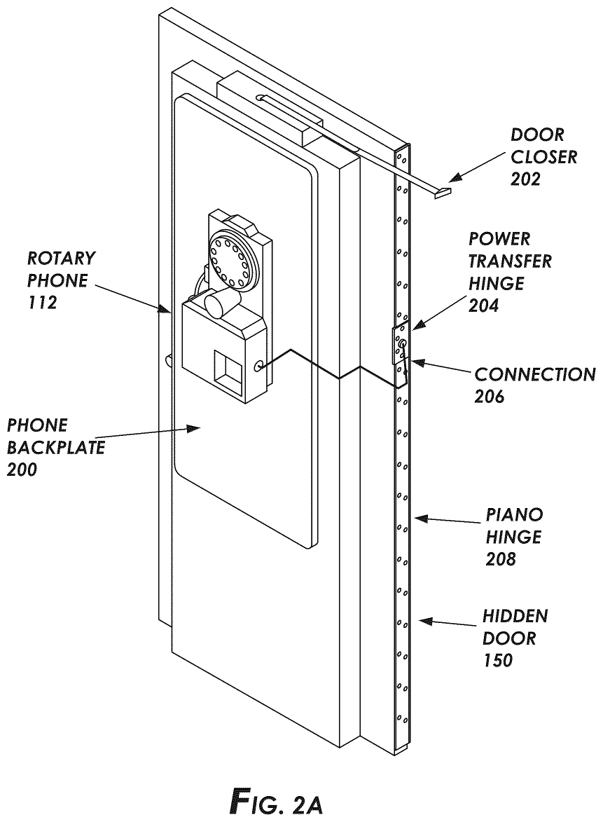

FIG. 1A shows a perspective view of a phone booth concealing a door into a building from an exterior side in accordance with one or more embodiments.

FIG. 1B shows a perspective view of a phone booth concealing a door into a building from an interior side in accordance with one or more embodiments.

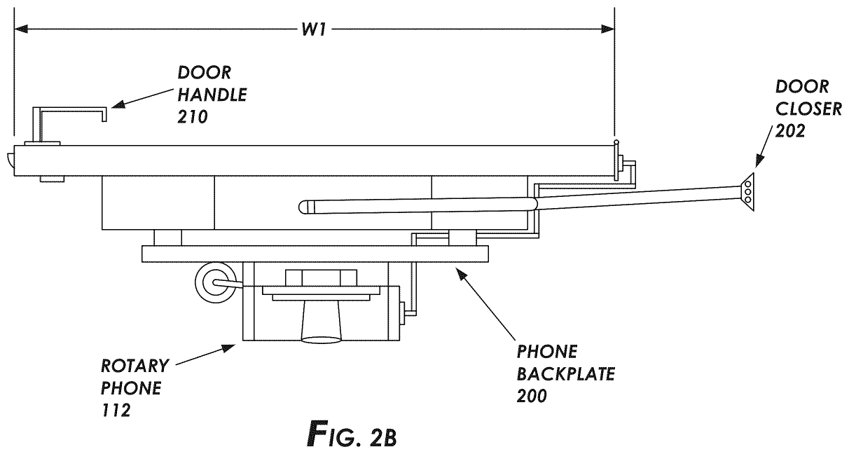

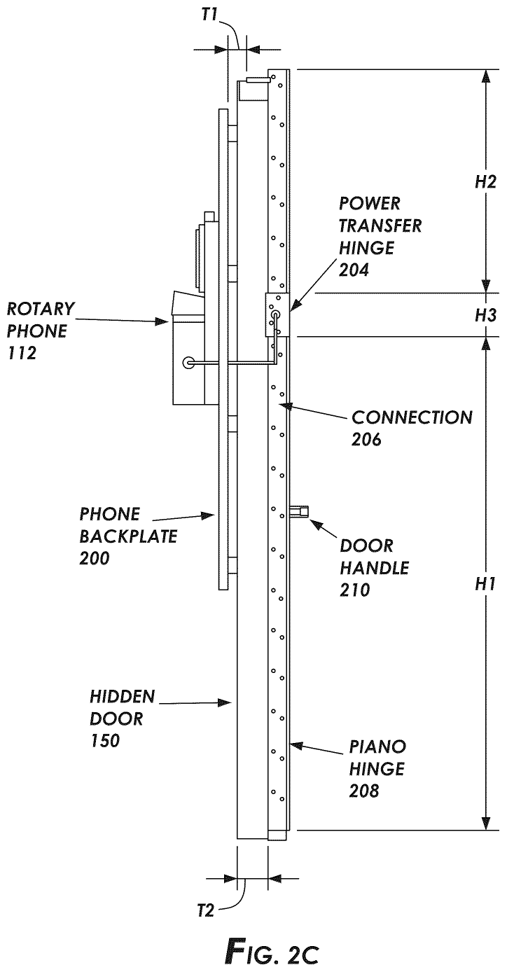

FIG. 2A shows a perspective view of a hidden door as would appear inside a phone booth in accordance with one or more embodiments.

FIG. 2B shows a top view of a hidden door in accordance with one or more embodiments.

FIG. 2C shows a side view of a hidden door in accordance with one or more embodiments.

FIG. 2D shows a front view of a hidden door in accordance with one or more embodiments.

FIG. 2E shows an enlarged view of a wire hole in a hidden door in accordance with one or more embodiments.

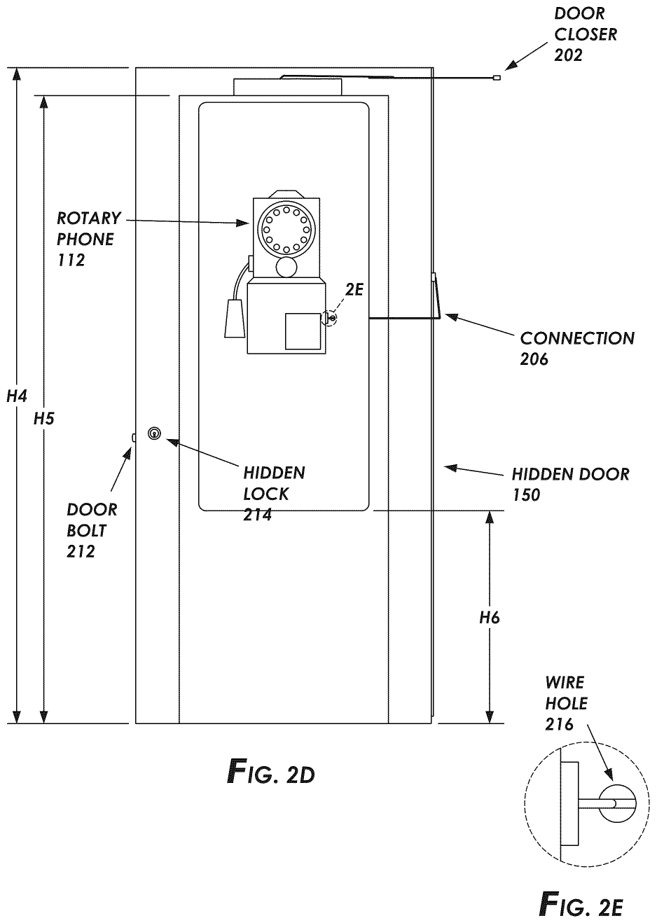

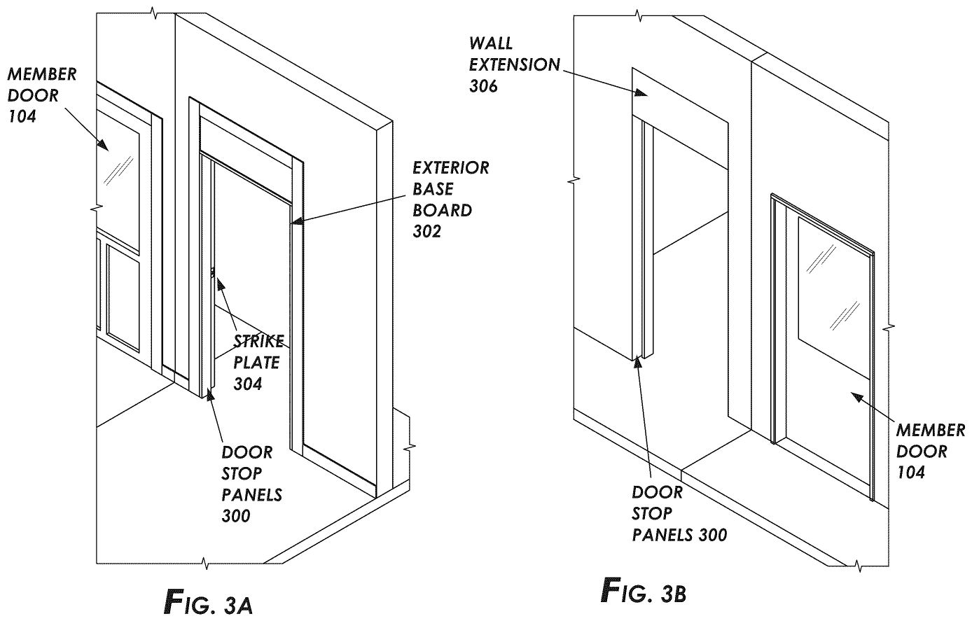

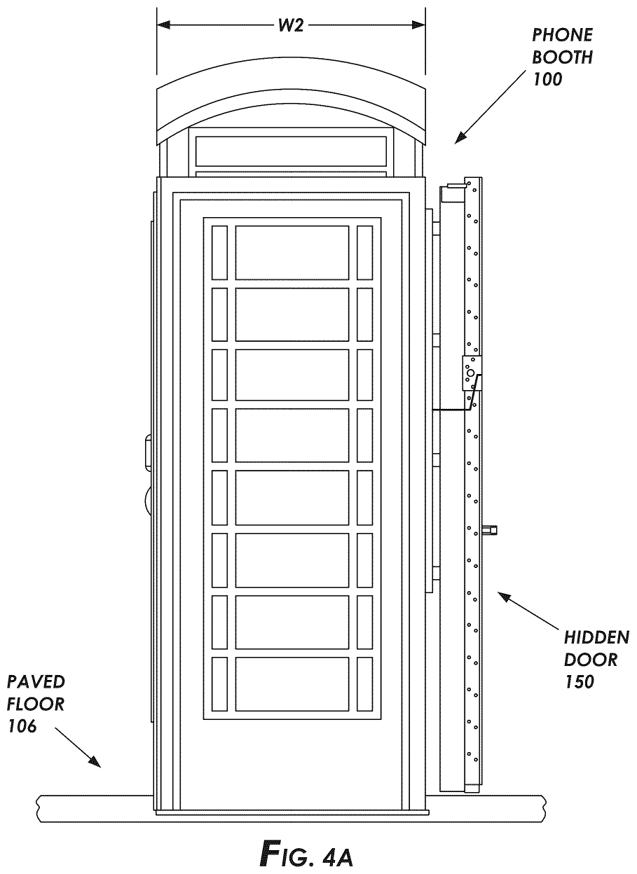

FIG. 3A shows a perspective view of a door frame of a hidden door from an exterior side in accordance with one or more embodiments.

FIG. 3B shows a perspective view of a door frame of a hidden door from an interior side in accordance with one or more embodiments.

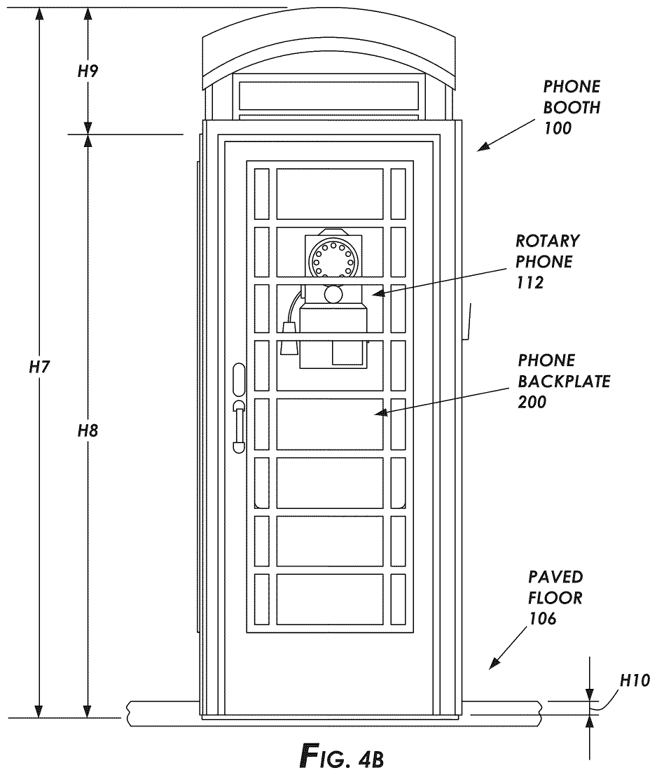

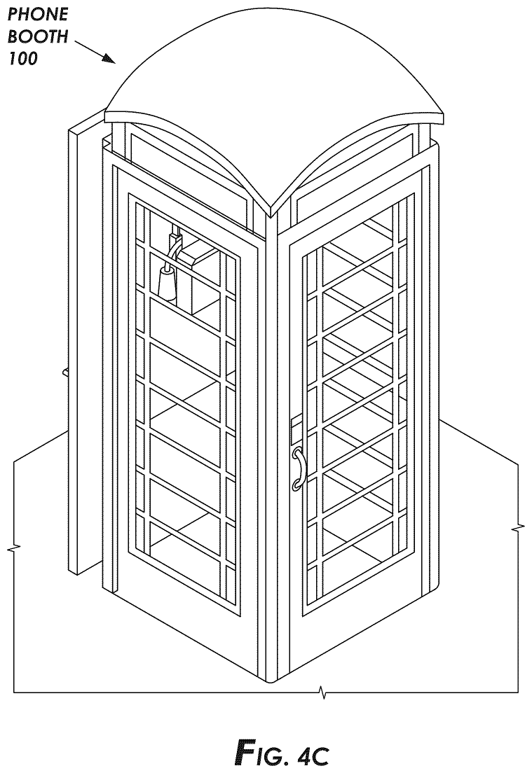

FIG. 4A shows a side view of a phone booth in accordance with one or more embodiments.

FIG. 4B shows a front view of a phone booth in accordance with one or more embodiments.

FIG. 4C shows a perspective view of a phone booth in accordance with one or more embodiments.

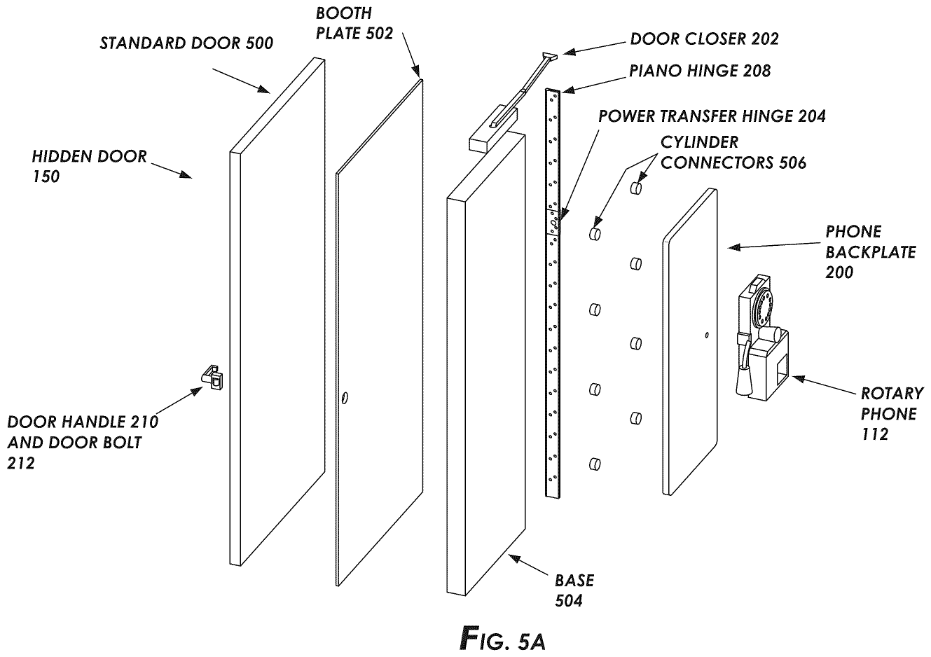

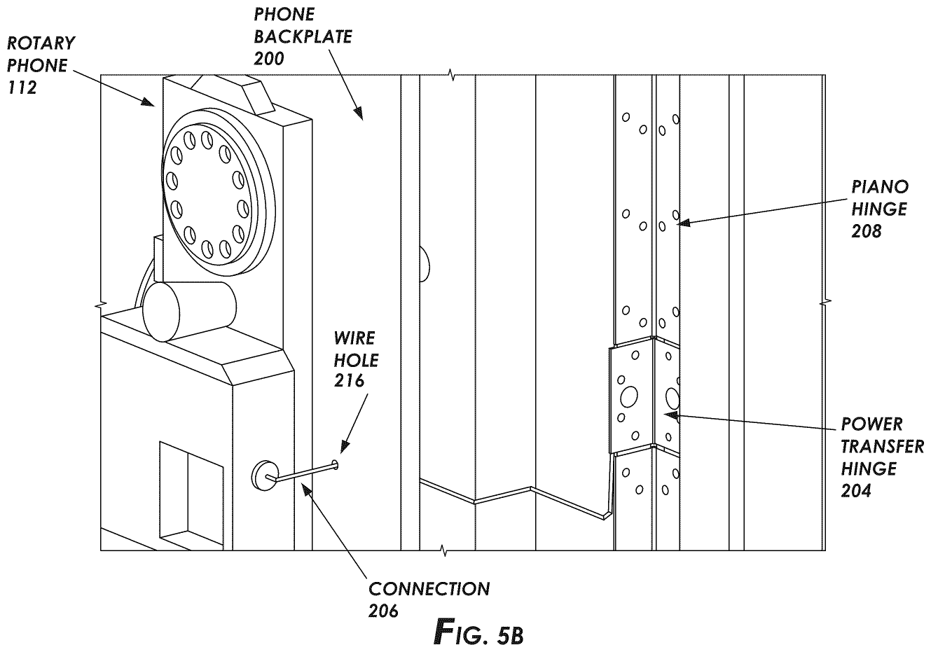

FIG. 5A shows an exploded view of a hidden door in accordance with one or more embodiments.

FIG. 5B shows an enlarged view of a connection in a hidden door in accordance with one or more embodiments.

### DETAILED DESCRIPTION

In the below description, numerous details are set forth as examples of embodiments described herein. It will be understood by those skilled in the art, and having the benefit of this Detailed Description that one or more embodiments described herein may be practiced without these specific details and that numerous variations or modifications may be possible without departing from the scope of the embodiments described herein. Certain details known to those of ordinary skill in the art may be omitted to avoid obscuring the description.

One challenge of having a hidden entrance is having the entrance be hidden while still being functional. A hidden door must be able to open and close while still being concealed. Hidden doors built into walls may be detected by elements of the door being visible. If not visible, an unmodified door may not properly open or close. For at least the reasons discussed above, a different hidden door including the mechanism and disguise may be beneficial.

In general, embodiments disclosed herein provide a hidden door mechanism disguised by a phone booth. The phone booth is positioned along a wall of a building to which the hidden door is providing an entrance. A booth wall of the phone booth along the wall is replaced with the hidden door. The hidden door includes a standard door that allows the hidden door to be opened and closed and a base that allows the hidden door to fit into the phone booth. The base includes a phone backplate and phone to disguise the hidden door as part of the phone booth. The door frame in the wall is modified to fit the standard door and the base to allow the hidden door to move from an open position to a closed position and vice versa. The phone is operatively connected to the other side of the wall via a wired connection to allow multiple options of opening and closing the door discussed below.

The following describes various embodiments disclosed herein.

Turning to FIG. 1A, FIG. 1A shows a perspective view of a phone booth concealing a door into a building from an exterior side in accordance with one or more embodiments. FIG. 1A includes a phone booth (100), a booth door (102), a member door (104), a paved floor (106), and a wall (110). The phone booth (100) includes a hidden door as shown in FIG. 1B. The booth door (102) allows a person to enter the phone booth to use the hidden door. The phone booth (100) includes two booth walls. The two booth walls, the booth door (102), and the hidden door make up the four walls of the phone booth (100). The phone booth (100) also includes a roof. The phone booth (100) is further described in FIGS. 4A-4C. The wall (110) is a wall of a building that the hidden door and the member door (104) provide entrance and exit to the building. FIG. 1A shows the exterior side of the wall (110). The two booth walls are connected to the wall (110) on the exterior side. The booth door (102) is approximately perpendicular with the two booth walls. The booth door (102) is approximately parallel with the hidden door. Adjacent to the phone booth (100) is the member door (104) which provides a second entrance and second exit to the building. In one or more embodiments. the member door (104) is used as an alternative entrance and exit to the hidden door. In one or more embodiments, the member door is positioned in a different location farther away from the hidden door to further hide the hidden door in the phone booth (100).

FIG. 1B shows a perspective view of a phone booth concealing a door into a building from an interior side in accordance with one or more embodiments. FIG. 1B shows an interior side of the wall (110) with the member door (104) also visible. A hidden door (150) is connected to the phone booth (100). The hidden door (150) is in an open position. The hidden door (150) is A rotary phone (112) is connected to the hidden door. In one or more embodiments. the rotary phone (112) is any type of telephone. The rotary phone (112) is used as a communication device and to disguise the hidden door (150) as a part of the phone booth (100). The hidden door (150) and the rotary phone are further described in FIGS. 2A-2E and 5A-5B.

FIG. 2A shows a perspective view of a hidden door as would appear inside a phone booth in accordance with one or more embodiments. In addition to the rotary phone (112), the hidden door (150) includes a phone backplate (200), a door closer (202), a power transfer hinge (204), a connection (206), and a piano hinge (208). The phone backplate (200) further disguises the hidden door (150) as a part of the phone booth (100). The rotary phone (112) is connected to the hidden door (150) via the phone backplate (200).

The door closer (202) is positioned on the top of the hidden door (150). The door closer (202) is a mechanical device that automatically returns the door to the closed position after it has been opened, using a spring and hydraulic damping mechanism to control speed and force. The door closer (202) is designed to provide consistent closing action and prevent slamming, even under the increased weight and inertia of the hidden door (150) which is heaver due to the modified components discussed in FIG. 5A. In the closed position, the hidden door (150) is disguised as a third booth wall of the phone booth (100) and bars entry through the wall (110) into the building. In the open position, the hidden door (150) allows entry into the building through the phone booth (100). The door closer (202) is a mechanical device that controls the movement and speed of the swing of the hidden door (150). The hidden door (150) is heavy and without a door closer (202) would close at a speed that can be unsafe. In one or more embodiments, the door closer (202) uses a spring to store potential energy when the hidden door (150) is opened that is released in a controlled way to close the hidden door (150).

The power transfer hinge (204) and the piano hinge (208) form a hinge system. The hinge system is connected to a side surface of the hidden door (150) and further assists with the door closer (202) assists in moving the hidden door (150). The hinge system secures the hidden door (150) to the wall (110) and acts as a pivot point for the hidden door (150). The piano hinge (208) (also known as a continuous hinge) is an elongated hinge that runs the full length of two adjoining surfaces, providing uniform support and load distribution along the entire joint. For the hidden door (150), the piano hinge (208) is used to minimize stress concentration at discrete points, ensuring smooth pivoting and enhanced durability under the substantial weight of the hidden door (150). The piano hinge (208) is cut down from a standard size to ensure the piano hinge (208) is of a build/grade to support the hidden door (150). The power transfer hinge (204) is a specialized hinge that incorporates concealed electrical wiring or conductive pathways, enabling the transfer of power and signals between the hidden door (150), the door frame, and the rotary phone (112) while maintaining a pivoting function. The power transfer hinge (204) is overlayed on the piano hinge (208). The connection with the rotary phone (112) is discussed in FIG. 5B. In one or more embodiments, the power transfer hinge (204) may be used to open the hidden door (150). The power transfer hinge (204) is positioned on the piano hinge (208) and is integrated into the hinge system to provide both structural support and a protected channel for powering integrated components like locks, sensors, or access control systems without external cabling.

The connection (206) includes a communication connector (e.g., a wire) that connects the rotary phone (112) to the power transfer hinge (204). This enables communication between the rotary phone (112) and the interior of the building. For example, a person can communicate in the phone booth (100) via the rotary phone (112) with another person standing past the interior side of the wall in the building. In one or more embodiments, the connection (206) may be used to transmit a code inputted into the rotary phone (112) that opens the door via an electric signal to the power transfer hinge (204). In one or more embodiments, the hidden door is opened by a person on the interior side of the wall that hears a code spoken by a person seeking entry into the rotary phone (112). The connection (206) is explained further in FIGS. 5A-5B.

FIG. 2B shows a top view of a hidden door in accordance with one or more embodiments. FIG. 2B shows the phone backplate (200), the rotary phone (112), and a door handle (210) of the hidden door (150). The door handle (210) is positioned on an interior side of the hidden door (150) opposite to the rotary phone (112). The door handle (210) is further discussed in FIG. 5A. At the largest portion, the hidden door (150) as a width (W1) of about three feet. This width is the width of a standard door. As discussed in FIG. 5A, other portions of the hidden door (150) have smaller widths to accommodate the hidden door (150) being hidden in the phone booth (100).

FIG. 2C shows a side view of a hidden door in accordance with one or more embodiments. In the hinge system, the piano hinge (208) is continuous but contains two sections (e.g., a first section and a second section) delineated by the power transfer hinge (204). The first section is above the power transfer hinge (204) and has a height (H2) of about one foot and 11.125 inches. The second section is below the power transfer hinge (204) and has a height (H1) of about four feet and 2.875 inches. The power transfer hinge (204) has a height (H3) of about 4.5 inches. Thus, the piano hinge (208) has a total height of six feet and 6.5 inches, nearly the entire height of the hidden door (150). The hidden door (150) includes a base, and a plurality of connectors discussed in FIG. 5A. As shown in FIG. 2C, the base has thickness (T2) of about 3.15625 inches. The plurality of connectors has a thickness (T1) of about one inch.

FIG. 2D shows a front view of a hidden door in accordance with one or more embodiments. The hidden door (150) further includes a hidden lock (214) and a door bolt (212) visible in the front view. The hidden lock (214) is a locking mechanism concealed within the door structure, making it invisible from the exterior side in the phone booth (100) while allowing secure engagement from the interior side. The hidden lock (214) prevents the door from being opened by a person standing in the phone booth and maintain a clean exterior appearance. The hidden lock (214) can be unlocked from the interior side of the hidden door (150). The hidden lock (214) is not visible to a person in the phone booth (100) because the hidden lock (214) is covered by the door frame and the booth wall when the hidden door is in the closed position. The door bolt (212) is a fastening device that slides a metal rod into a strike plate (see FIGS. 3A-3B) to secure the hidden door (150) in a closed position. The door bolt (212) reinforces the hidden door (150) against lateral movement. The sliding of the metal rod of the door bolt (212) is controlled manually by a person turning the door handle (210). In one or more embodiments, the door bolt (212) is operatively connected to the power transfer hinge (204) to allow for automatic control of the sliding of the metal rod. The hidden door (150) has various height measurements. A base door (discussed in FIG. 5A) of the hidden door (150) has a height (H4) of about six feet and eight inches. The base has a height (H5) of about six feet and 4.5 inches. The phone backplate is positioned a height (H6) of about two feet and two inches above the paved floor (106). The phone backplate (200) extends from that point to near the top of the base.

FIG. 2E shows an enlarged view of a wire hole (216) in a hidden door in accordance with one or more embodiments. The wire hole (216) in the phone backplate (200) allows the connection (206) to pass through the phone backplate (200) and connect to the power transfer hinge (204) hidden from view of anyone in the phone booth (100).

FIG. 3A shows a perspective view of a door frame of a hidden door from an exterior side in accordance with one or more embodiments. The phone booth (100) and hidden door (150) are removed for ease of viewing the door frame. The door frame frames an opening that the hidden door (150) moves through when opening and fills when the hidden door (150) is in the closed position. The door frame includes the door stop panels (300), the exterior base board (302), and the strike plate (304). The door stop panels (300) are a strip of material attached to the three sides of the door frame that defines where the hidden door (150) is positioned in the closed position. The door stop panels (300) prevent the hidden door (150) from opening in the wrong direction and creates a seal around the hidden door (150). The door stop panels (300) also fill the gap at the top of the door frame to ensure no light from the interior of the building leaks into gaps of the phone booth (100). The strike plate (304) is a metal plate mounted on the door frame that reinforces the area where the metal rod of door bolt (212) enters the door frame. The strike plate (304) provides a secure and durable surface for keeping the hidden door (150) in the closed position and locking mechanisms. The strike plate (304) prevents wear and distributes impact forces, ensuring reliable alignment and resistance to forced entry. The strike plate (304) assists holding the hidden door (150) in the closed position and prevents the hidden door (150) from opening in the wrong direction. The exterior base board (302) extends into the opening to allow the base to extend up to the position in the phone booth to appear as the third booth wall. The exterior base board (302) is sized to fit the base and to allow the base to move from the open position to the closed position and vice versa.

FIG. 3B shows a perspective view of the door frame of a hidden door from an interior side in accordance with one or more embodiments. The door frame further includes a wall extension (306) that extends the wall down from the top of the opening that is the height of the phone booth (100) to the height of the hidden door (150). The wall extension (306) is discussed further in FIGS. 4A-4C.

FIG. 4A shows a side view of a phone booth in accordance with one or more embodiments. The phone booth (100) and the hidden door (150) are visible. The width (W2) of the phone booth (100) is about three feet. In one or more embodiments, the phone booth (100) has a square base, and the thickness is equal to the width. The width (W2) of the phone booth (100) is equal to the largest width of the hidden door (150) to conceal the hidden door (150).

FIG. 4B shows a front view of a phone booth in accordance with one or more embodiments. The phone booth (100), rotary phone (112), and the phone backplate (200) are visible. The phone booth (100) has a total height (H7) of about eight feet and two inches. The compartment that holds the rotary phone (112) has a height (H8) of about six feet and eight inches. The height (H8) of the phone booth (100) is equal to the greatest height of the hidden door (150) to conceal the hidden door (150). The roof of the phone booth (100) has a height (H9) of about one foot and six inches. The phone booth (100) is embedded into the paved floor (106) to enhance the realism of the phone booth (100), thus further disguising the hidden door (150). The phone booth (100) is embedded a height (H10) of between about one inch to about two inches. The phone booth is embedded also to create an even transition from the phone booth (100) and the paved floor (106) to prevent tripping.

FIG. 4C shows a perspective view of a phone booth in accordance with one or more embodiments. The wall (110) is removed to better view the phone booth (100). The perspective view highlights the square shape of the base of the phone booth (100) and the rounded roof of the phone booth (100). The phone booth has a handle on the booth door to allow a person to open the booth door and enter the phone booth (100).

FIG. 5A shows an exploded view of a hidden door in accordance with one or more embodiments. The hidden door (150) includes the rotary phone (112), the phone backplate (200), the power transfer hinge (204), the piano hinge (208), the door closer (202), the door handle (210), and the door bolt (212) as described above. The hidden door (150) further includes a standard door (500), a booth plate (502), a base (504), and a plurality of cylinder connectors (506). The standard door (500) (e.g., base door) is a standard size for a door with the dimensions discussed in FIGS. 3A-3B (e.g., height (H4) and width (W1)). The standard door (500) includes a first side, a second side, a first edge, and a second edge. The first side is on the interior side of the wall and includes the door handle (210). The door handle (210) is connected to the door bolt (212) which is positioned inside the standard door (500) extending out of the first edge. The door bolt (212) connects with the strike plate (304) when the hidden door (150) is in the closed position. The hinge system including the power transfer hinge (204) and the piano hinge (208), are connected to the second edge of the standard door (500) and the door frame in the wall (110) to allow the rotational motion of the hidden door (150). The standard door (500) is connected to the booth plate (502) on the second side. The booth plate (502) (e.g., plate) is designed to look like (e.g., resemble) the booth walls of the phone booth (100). In one or more embodiments, the booth plate includes a hole to allow the hidden lock to extend into the base (504).

The base (504) includes a top surface, a first side surface, and a second side surface. The door closer (202) is positioned on the top surface of the base (504) and is connected to the standard door (500). The second side surface of the base (504) is connected to the booth plate (502). The base (504) is sized to fit into the phone booth between the two booth walls to disguise the hidden door. When the hidden door (150) is in the closed position, the base (504) acts as a third booth wall of the phone booth (100). The base (504) is smaller than the standard door (500) to fit into the phone booth (100). The width and height of the base (504) are both less than the width and height of the standard door (500). Because the base (504) fits into the phone booth (100) and the door closer (202) is positioned above the base (504), the door closer (202) is hidden when the hidden door (150) is in the closed position. The thickness (T2) of the base (504) is greater than the thickness of the standard door (500). This additional thickness accounts for the increased weight of the hidden door (150) which is accounted for by using the piano hinge (208) and the door closer (202).

The phone backplate (200) is connected to the first side surface of the base (504) by the plurality of cylinder connectors (506). In one or more embodiments, the plurality of cylinder connectors (506) includes eight cylinder connectors. The thickness (T1) corresponds to the thickness of the plurality of cylinder connectors (506). The rotary phone (112) is connected to the phone backplate (200) on the opposite side as the plurality of cylinder connectors (506). The phone backplate (200) includes the wire hole (216).

FIG. 5B shows an enlarged view of a connection in a hidden door in accordance with one or more embodiments. FIG. 5B shows the rotary phone (112) connected to the connection (206). The connection (206) goes through the phone backplate (200) via the wire hole (216). The connection (206) connects to the power transfer hinge (204). The power transfer hinge (204) facilitates an electric transmission from the rotary phone (112) through the door frame to the other side of the wall (110). In one or more embodiments, the power transfer hinge (204) is replaced with grooves and/or ports in the piano hinge (208) to enable the connection (206) to pass through to the other side of the wall (110) and carry through the electric transmission.

In one or more embodiments, the electric transmission is communication from a person in the phone booth (100) that is transmitted through to a speaker (not shown) on the internal side of the wall (110). The communication may be interpreted by a second person on the internal side of the wall (110) and may lead to that second person opening the hidden door (150) with the door handle (210) to allow the person to enter. In one or more embodiments, the electric transmission may be a code entered through the rotary phone (112) (e.g., a number code inputted into the rotary phone (112). If the code is correct, the power transfer hinge may automatically cause the hidden door (150) to open from the closed position to the open position.

The problems discussed above should be understood as being examples of problems solved by embodiments of the disclosure disclosed herein and the disclosure should not be limited only to solving the same/similar problems. The disclosure is broadly applicable to address a range of problems beyond those discussed herein.

Specific embodiments are described with reference to the accompanying figures. In the above description, numerous details are set forth as examples. It will be understood by those skilled in the art, that one or more embodiments of the present disclosure may be practiced without these specific details, and that numerous variations or modifications may be possible without departing from the scope. Certain details known to those of ordinary skill in the art are omitted to avoid obscuring the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

As used herein, “about” and “approximately” are used to demonstrate that the given value includes a small range of values both greater than and less than the given value (e.g., there exists a range of values contemplated that would satisfy by the given value). This range is meant to extend 15% above and below the given value. For example, about 100 and approximately 100 would mean between 85 and 115.

While the disclosure has been described above with respect to a limited number of embodiments, those skilled in the art, having the benefit of this disclosure, will appreciate that other embodiments can be devised which do not depart from the scope as disclosed herein. Accordingly, the scope of the disclosure should be limited only by the attached claims.

What is claimed is:

1. A system, comprising:
a phone booth, comprising a booth door and two booth walls, wherein the two booth walls are connected to an exterior side of a wall of a building and are perpendicular with the booth door and wherein the phone booth is embedded into a ground surface;
a hidden door parallel to the booth door and, when opened, provides access to an interior portion of the building;
a telephone backplate to disguise the hidden door; and
a telephone connected to the telephone backplate, wherein the telephone facilitates communication via a communication connector between the phone booth and an interior side of the wall in the building.

2. The system of claim 1, wherein the hidden door is opened using a code inputted into the telephone.

3. The system of claim 1, wherein the hidden door is opened via a door handle on the hidden door on the interior side of the wall.

4. The system of claim 1, wherein the hidden door comprises:
a base door with a first side and a second side, wherein the first side is on the interior side of the wall and includes a handle and wherein the base door is sized to fit into a door frame in the wall;
a plate connected to the second side of the base door;
a base comprising a top surface, a first side surface, and a second side surface, wherein the base is connected to the plate on the second side surface and wherein the base is sized to fit into the phone booth between the two booth walls to disguise the hidden door, when closed as a third booth wall of the phone booth and is smaller than the base door;
a door closer connected to a door handle and positioned on the top surface of the base, wherein the door closer assists in moving the hidden door from a closed position and an open position;
a hinge system connected to the base door and the wall, wherein the hinge system further assists in moving the hidden door by securing the hidden door to a pivot point on the wall; and
the telephone backplate connected to the base with a plurality of connectors.

5. The system of claim 4, wherein the hinge system includes a piano hinge with two sections delineated by a power transfer hinge overlayed on the piano hinge.

6. The system of claim 5, wherein a first section of the piano hinge has a height of about one foot and 11.125 inches, a second section of the piano hinge has a second height of about four feet and 2.875 inches, and the power transfer hinge has a third height of about 4.5 inches.

7. The system of claim 5, wherein the power transfer hinge facilitates the communication via the communication connector between the telephone and the interior side of the wall in the building.

8. The system of claim 4, wherein the base door has a height dimension of about six feet and eight inches and a width dimension of about three feet and the base has a second height dimension of about six feet 4.5 inches and a second width of less than three feet.

9. The system of claim 4, wherein the hidden door is positioned into the door frame of the wall with door stop panels and a wall extension to fit the hidden door into the wall and wherein the hinge system connects to the door frame of the wall.

10. The system of claim 1, wherein the hidden door comprises a hidden lock to prevent being opened directly from the phone booth.

11. A hidden door, comprising:
a base door with a first side and a second side and a door bolt, wherein the first side includes a door handle connected to the door bolt and wherein the base door is sized to fit into a door frame and wherein the door handle is configured to open the hidden door;
a plate connected to the second side of the base door to resemble a wall of a phone booth;
a base comprising a top surface, a first side surface, and a second side surface, wherein the base is smaller than the base door and wherein the base is connected to the plate on the second side surface;
a door closer connected to the door handle and positioned on the top surface of the base, wherein the door closer assists in moving the hidden door from a closed position and an open position;
a piano hinge connected to the base door and configured to support a weight of the hidden door;
a power transfer hinge connected to the piano hinge;
a telephone backplate connected to the base with a plurality of connectors; and
a telephone attached to the telephone backplate, wherein the telephone is connected to the power transfer hinge via a communication connector between the telephone and an interior side of the hidden door.

12. The hidden door of claim 11, wherein the piano hinge has two sections delineated by the power transfer hinge overlayed on the piano hinge.

13. The hidden door of claim 12, wherein a first section of the piano hinge has a height of about one foot and 11.125 inches, a second section of the piano hinge has a second height of about four feet and 2.875 inches, and the power transfer hinge has a third height of about 4.5 inches.

14. The hidden door of claim 11, wherein the base door has a height dimension of about six feet and eight inches and a width dimension of about three feet and the base has a second height dimension of about six feet 4.5 inches and a second width of less than three feet.

15. A system, comprising:
a phone booth, comprising a booth door and two booth walls, wherein the two booth walls are connected to an exterior side of a wall of a building and are perpendicular with the booth door and wherein the phone booth is embedded into a ground surface;
a hidden door parallel to the booth door and, when opened, provides access to an interior portion of the building, the hidden door comprising:
a base door with a first side and a second side, wherein the first side is on an interior side of the wall and includes a handle and wherein the base door is sized to fit into a door frame in the wall,
a plate connected to the second side of the base door,
a base comprising a top surface, and a first side surface connected to the plate on a second surface facing the plate, wherein the base is sized to fit into the phone booth between the two booth walls to disguise the hidden door, when closed, as a third booth wall of the phone booth,
a door closer, connected to a door handle and the base door, positioned on the top surface of the base, wherein the door closer assists in moving the hidden door from a closed position and an open position, and
a hinge system connected to the base door and the wall, wherein the hinge system further assists in moving the hidden door by securing the hidden door to a pivot point on the wall;
a telephone backplate connected to the base of the hidden door to disguise the hidden door; and
a telephone connected to the telephone backplate, wherein the telephone facilitates communication via a communication connector between the phone booth and the interior side of the wall in the building.

16. The system of claim 15, wherein the hidden door is opened using a code inputted into the telephone.

17. The system of claim 15, wherein the hidden door is opened via the door handle on the hidden door on the interior side of the wall.

18. The system of claim 15, wherein the hinge system includes a piano hinge with two sections delineated by a power transfer hinge overlayed on the piano hinge.

19. The system of claim 15, wherein the hidden door is positioned into the door frame of the wall with door stop panels and a wall extension to fit the hidden door into the wall and wherein the hinge system connects to the door frame of the wall.

20. The system of claim 15, wherein the hidden door comprises a hidden lock to prevent being opened directly from the phone booth.
